(19) United States
(12) Patent Application Publication
(10) Pub. No.: US 2023/0281608 A1
(43) Pub. Date: Sep. 7, 2023

(54) PROCESSING PURCHASE WITH AUTHORIZATION TOKEN

(71) Applicant: Wells Fargo Bank, N.A., San Francisco, CA (US)

(72) Inventor: Joon Maeng, Newcastle, WA (US)

(21) Appl. No.: 18/318,169

(22) Filed: May 16, 2023

Related U.S. Application Data
(62) Division of application No. 15/633,127, filed on Jun. 26, 2017.

(51) Int. Cl. G06Q 20/36; G06Q 20/38

(52) U.S. Cl. CPC G06Q 20/3674; G06Q 20/38215; G06Q 20/3829

(57) ABSTRACT

Various examples described herein are directed to systems and methods for executing a mobile wallet application. The mobile wallet application may receive an invoice from the merchant application. The mobile wallet application may end the invoice and an indication to pay the invoice to a mobile wallet application provider. The mobile wallet application provider facilitates the payment of the invoice. An authorization token is passed from the mobile wallet application provider to the mobile wallet application. The mobile wallet application sends the authorization token to the merchant application. The authorization token is verified by the merchant application to confirm payment of the invoice.

### CROSS-REFERENCE TO RELATED APPLICATION

This application is a divisional of U.S. patent application Ser. No. 15/633,127, filed Jun. 26, 2017, which is incorporated by reference herein in its entirety.

### TECHNICAL FIELD

Embodiments described herein generally relate to systems and methods for secure communications between mobile wallet applications executing at mobile computing devices and, optionally, between one or more merchant applications.

### BACKGROUND

Mobile wallet applications can allow consumers to make payments for products and services using mobile computing devices instead of cash, credit card accounts, check card, or checks.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 is a diagram showing one example of a mobile wallet environment.

FIG. 2 is a diagram showing a mobile shopping application and a mobile wallet application.

FIG. 3 is a timing diagram showing one example for processing a payment using the mobile wallet integrated with the merchant application.

FIG. 4 is a diagram showing one example of a mobile wallet application to mobile wallet application secure digital communication.

FIG. 5 is a block diagram showing an example architecture of a mobile computing device.

FIG. 6 is a block diagram showing one example of a software architecture for a computing device.

FIG. 7 is a block diagram illustrating a computing device hardware architecture, within which a set or sequence of instructions can be executed to cause the hardware to perform examples of any one of the methodologies discussed herein.

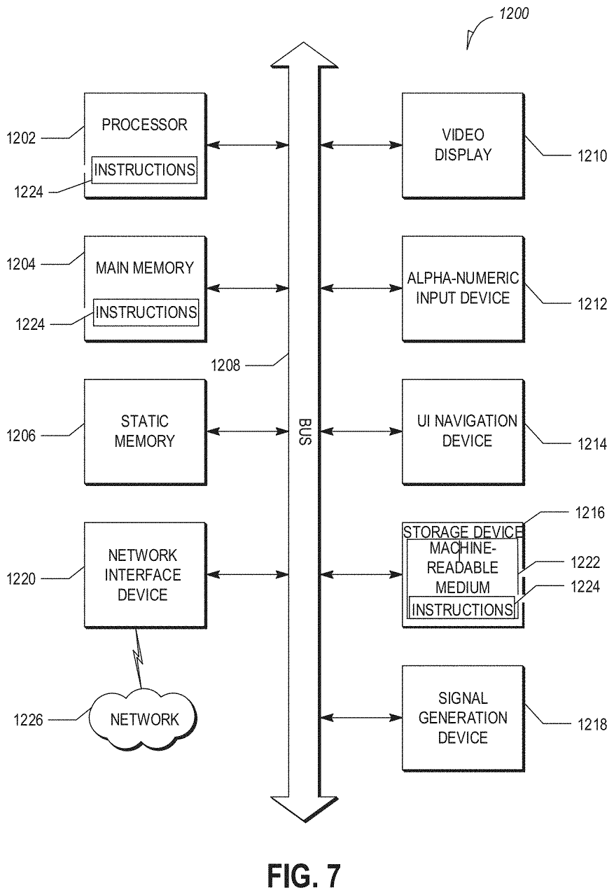

### DETAILED DESCRIPTION

A user may utilize a mobile wallet application for providing payment to or conducting other transactions with a merchant. In many cases, users may create an account with the merchant containing personal and/or financial information. For example, user data stored as part of the user's account may include the account holder's name, shipping address, billing address, credit card numbers, etc. The merchant may store this user information, allowing a user to purchase goods and/or services without having to reenter credit card information. Merchants storing the credit card information for lots of users make the merchant's data valuable to hackers. Providing merchants and users with the ability to make transactions without the user having to reenter billing information and without the merchant having to store the user's billing information would be helpful. As described below, processing payments directly with a mobile wallet may allow merchants to process transactions without requiring users to reenter credit card information and without having to store the credit cards information on the merchant's systems. This may reduce risks associated with credit card theft. Further, processing payments may allow merchants to bypass fees charged by various payment networks.

In various examples described herein allow for the merchant application to forgo storing user payment information. In addition, the user payment information is not stored on the merchant's system either. Instead, user payment information is stored with the mobile wallet provider. The mobile wallet application may access the mobile wallet provider to indicate which account should be used for payment of an invoice. In this example, the user's payment information is not stored on the user device or the merchant system.

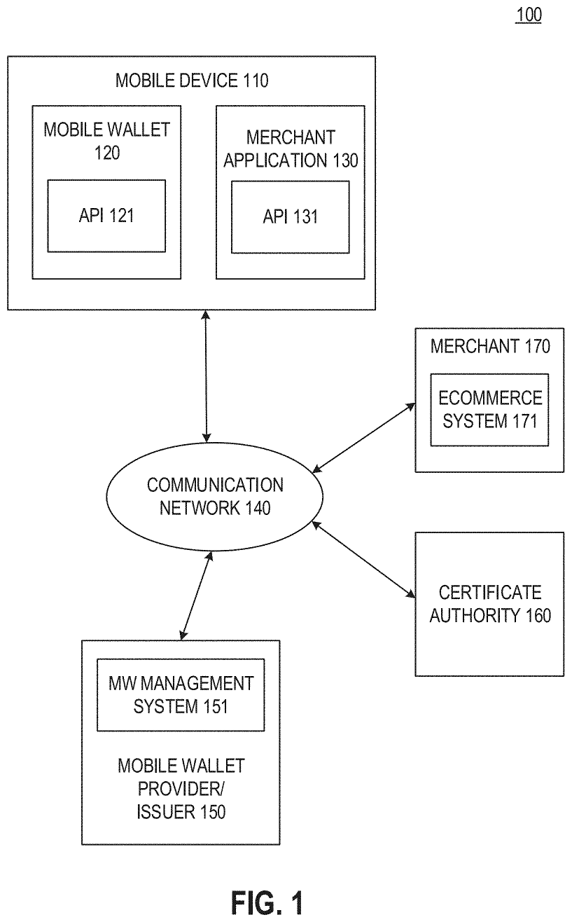

FIG. 1 is a diagram showing one example of a mobile wallet environment 100. The environment 100 includes a mobile device 110, a communication network 140, a mobile wallet provider/issuer 150, a certificate authority 160, and a merchant 170.

The mobile device 110 includes a mobile wallet 111 and a merchant application 130. The mobile wallet 120 is an application program that runs in a computing device. The computer device includes mobile devices such as smartphones and tablet computers. The mobile wallet 120 allows an individual to make electronic commerce transactions, which may include purchasing items and making payments. Exemplary mobile wallets are Wells Fargo Wallet®, Apple Pay®, Google Wallet®, PayPal®, Samsung Pay®, and Starbucks App®. The mobile wallet includes one or more of payment elements (not shown) and non-payment elements (not shown). Exemplary payment elements include but are not limited to a credit card, a debit card, and a bank account. Exemplary non-payment elements are a passport, a driver's license, an insurance card, an employee card, a student ID, and a member card. The user may select a payment element in the mobile wallet 120 and tap the mobile device 110 with a point of sale terminal at a brick-and-mortar store. The user may then make a payment over a near field communication (NFC).

A merchant application 130 is an application associated with the merchant 170. The merchant application 130 may be downloaded from the merchant 170 or from an application store. The merchant application 130 is also installed in the mobile device 110. For instance, the Amazon.com® mobile shopping application may be the merchant application 130 and Amazon® may be the merchant 170. The mobile wallet 120 and the merchant application 130 include application program interfaces (API) 121 and 131 which enable them to communicate each other. In another embodiment, the mobile wallet 120 and the merchant application 130 use a standard protocol to interface with one another. In other examples, one or more ecommerce transaction protocols such as EDI, SET, OBI, and OTP, may be used for communication between the mobile wallet and merchant application. The merchant application 130 may identify mobile wallets that are installed on the mobile device 110. The merchant application 130 may search the mobile device 110 for mobile wallets. In an example, the merchant application 130 may search an account associated with the mobile device 110 at an application store for mobile wallet applications. In addition, the merchant application 130 may determine what mobile wallet applications are available to exchange transactional information. For example, the merchant application 130 may request data from each mobile wallet application using the interfaces discussed above. The merchant application 130 may also search a remote database using the list of discovered mobile wallets to determine which mobile wallets the merchant application 130 may interface. The search results may also indicate how the merchant application 130 is to interface with each mobile wallet. In one embodiment, a web browser may serve as a bridge between mobile wallet and online store accessed via the web browser.

The merchant application 130 may determine there are multiple mobile wallets available for use in paying for a purchase. The merchant application 130 may determine if a mobile wallet has an incentive. In an example, the merchant application 130 may query a merchant ecommerce system 171. The merchant application 130 may pass a list of mobile wallets to the merchant ecommerce system 171. The merchant ecommerce system may determine if there are any promotions or incentives for each of the mobile wallets. In another example, a mobile wallet provider/issuer 150 may be contacted by either the merchant application 130 and/or the merchant ecommerce system 171 to determine available promotions or incentives. In an example, invoice data is included in searching for promotions or incentives. For example, using a particular mobile wallet to purchase a particular brand of product may be used to determine an available incentive. The incentive may be sent back to the merchant application 130. The merchant application 130 may then display each available incentive and/or discount. If a user selects one of the mobile wallets with an incentive and/or discount, the merchant application 130 or the merchant ecommerce system 171 may provide the invoice data to the mobile wallet provider/issuer 150. In an example, the merchant ecommerce system 171 may apply the discount or incentive to the current purchase.

The merchant application 130 may communicate with a merchant ecommerce system 171. For example, a shopper may select a product to purchase and request an invoice from the merchant ecommerce system 171. In this example, the merchant ecommerce system 171 may produce an invoice that is sent to the merchant application 130. The merchant application 130 may present the invoice on the mobile device 110. In an example, the merchant application 130 may provide the invoice to the mobile wallet 120 using the APIs 121 and 131.

A mobile wallet (MW) provider/issuer 150 is a provider of the mobile wallet 120 application and provides services associated with the mobile wallet 120. The mobile wallet provider 150 may also be an issuer (e.g., a financial institution) of the payment elements in the mobile wallet 120. Wells Fargo® is an example of such an organization which provides both the mobile wallet application 120 and payment elements that are used in the mobile wallet application 120. An example of a mobile wallet application is Wells Fargo Wallet®. In an embodiment, the mobile wallet provider 150 is different from the issuer. Apple® is a mobile wallet provider of Apple Pay® and the payment elements in Apple Pay® may be issued by banks for instance. In this embodiment, the mobile wallet provider 150 serves as a bridge between the mobile wallet 120 and the issuer accessed via the web browser.

A certificate authority (CA) 160 or certification authority is an entity that issues digital certificates. A digital certificate certifies the ownership of a public key by the named subject of the certificate. A CA is a trusted third party—trusted both by the owner of the certificate and by the party relying upon the certificate.

A communication network 140 is virtual representation of one or more communication media or methods which provide communication between entities 110, 150, 160, and 170. The communication network may include the Internet, a mobile network, a local area network, a home network, a personal area network, a Wi-Fi® network, a Bluetooth® connection, or others.

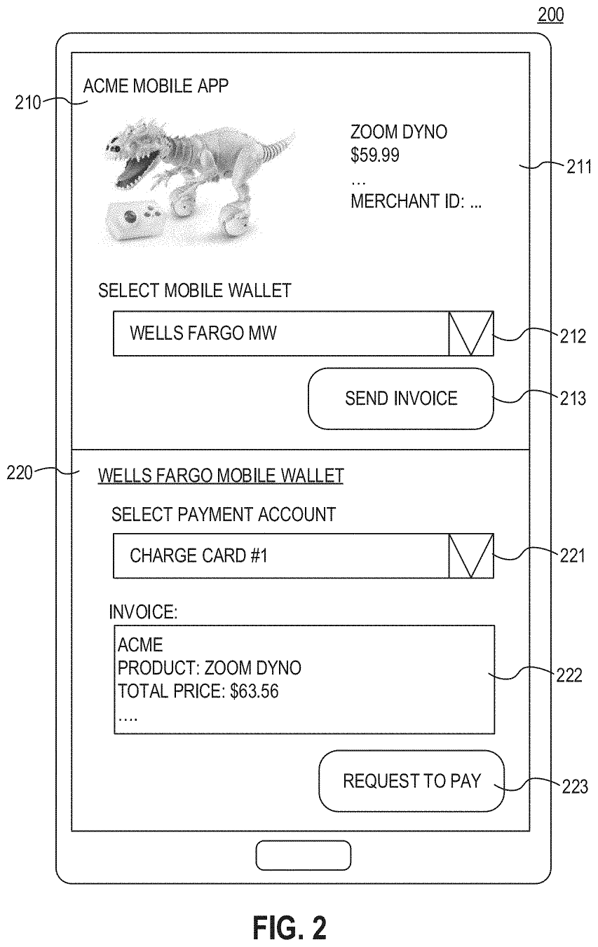

A shopper may use the merchant application 130 in the mobile device 110 to purchase products/services. FIG. 2 is a diagram showing a mobile shopping application and a mobile wallet application. The shopper may open the merchant application 210 from a mobile device 200. Once open, the shopper may select a product 211 using the merchant application 210. The merchant application 210 may show the description of the product 211 chosen by the shopper. The merchant application 210 may also query the mobile device 200 for a list of mobile wallets stored on the mobile device 200 via the API. The merchant application displays a list of mobile wallets it can communicate in the box 212. The shopper can select a mobile wallet of choice in the box 212, for instance Wells Fargo Mobile Wallet®. The shopper may touch the send invoice button 213. Once the send invoice button 213 is touched, the merchant application 210 may send the invoice to the selected mobile wallet 220, e.g., the Wells Fargo Mobile Wallet®.

The mobile device 200 may open Wells Fargo Mobile Wallet 220. The mobile wallet 220 may be opened at the bottom as shown in FIG. 2. In an embodiment, the mobile wallet window may replace the merchant application window. The mobile wallet window presents a set of payment accounts in the selection menu 221. The mobile wallet 220 receives a payment element selection that may be chosen by the shopper. The mobile wallet 220 may show an invoice 222 associated with the selected product. The shopper touches a request to pay button 223 to request the issuer of the selected payment account to make payment. When the request to pay button 223 is selected, the mobile wallet 220 receives an indication that the current invoice is to be paid from the selected payment account. To pay an invoice, the mobile wallet application 220 contacts the issuer of the selected payment account to pay the invoice. In the example illustrated in FIG. 2, the issuer is also the mobile wallet provider, Wells Fargo®.

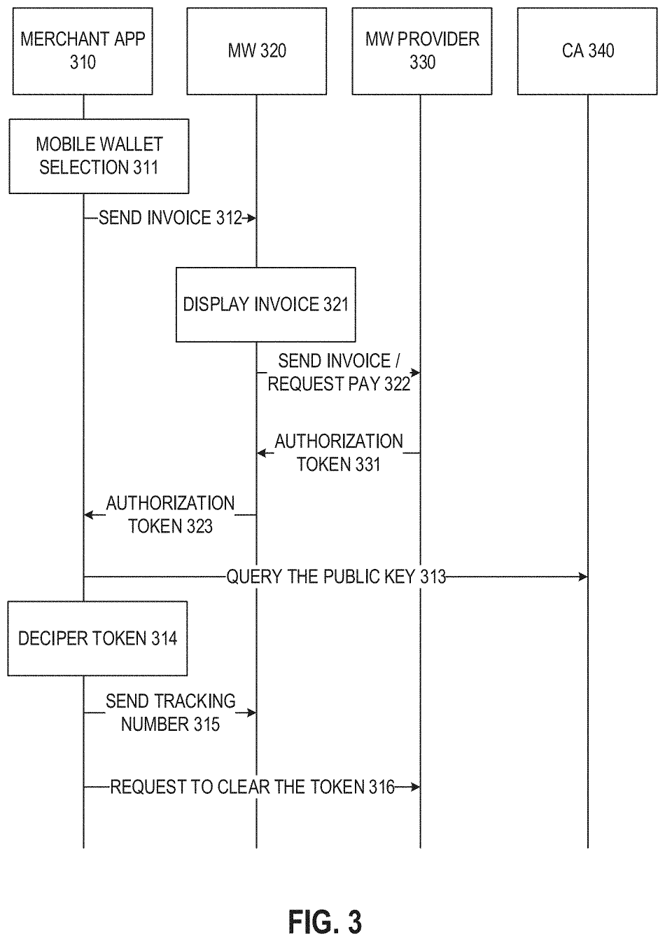

FIG. 3 is a timing diagram showing one example for processing a payment using a mobile wallet 320 integrated with a merchant application 310. A user may select one or more products to purchase using the merchant application 310. The merchant application 310 may determine how many mobile wallets are installed and can integrate with the merchant application 310. A list of available mobile wallets may be presented to a user. The merchant application 310 may receive a selection of a mobile wallet to use to pay for the products as shown at 311.

Once the mobile wallet 320 is selected, the invoice may be sent to the mobile wallet as shown at 312. The invoice may include data such as a product identifier, an invoice ID (which is unique), a description, a total price, a date, a unique merchant ID, etc. The merchant application 310 and the mobile wallet 320 may exchange information via an application program interface (API). Using the API, the mobile wallet 320 and the merchant application 310 may both be installed on the same user device.

Once received, the mobile wallet 320 may display the invoice for the user as shown at 321. The display may include product pricing details. In addition, a pay invoice button or other user interface component may be displayed. The user may select a payment element that will be used to pay the invoice. For example, the user may select which credit card or account will be used to pay the invoice. The user may select the pay invoice button using the selected payment element. The mobile wallet 320 receives the pay invoice selection and in response, sends the invoice data to the mobile wallet provider 330 as shown at 322. This may include sending invoice data such as the selected payment element, an invoice identifier, an invoice amount, etc.

The mobile wallet provider 330 may facilitate payment of the invoice. In an example, the mobile wallet provider 330 is the same entity as the issuer of the credit/debit card associated with the payment element that is used for payment. In another example, the mobile wallet provider 330 sends invoice data (e.g., the invoice amount, product identifier, an invoice ID (which is unique), a description, a total price, a date, a unique merchant ID) and an indication of the account to use to pay the invoice to the issuer. In addition, payment credentials for the selected payment element may also be sent to the issuer. In both examples, the issuer may debit the account to pay for the invoice and provide an indication to the mobile wallet provider 330 that the invoice has been paid.

After receiving the invoice/invoice information and a request to pay the invoice, the mobile wallet provider 330 receives an authorization token. If the mobile wallet provider is the same entity as the issuer, as described in Wells Fargo® case, the provider which is an issuer issues an authorization token. The authorization token may be encrypted with a private key of the issuer. The encrypted authorization token is sent as shown at 331 to the mobile wallet 320. The mobile wallet 320 sends the authorization token as shown at 323 to the merchant application 310. The authorization token may be exchanged between the mobile wallet 320 and the merchant application 310 via the API. The authorization token may include data such as an issuer identifier, an invoice identifier, an authorization identifier, and other data. The public key of the companion private key is registered with the certificate authority (CA) 340. In addition, the mobile wallet may provide the merchant application with an issuer identifier that identifies the issuer that created the authorization token.

The merchant application 310 queries a certificate authority 340 for the public key of the issuer. For example, the merchant application 310 may pass the issuer identifier to the certificate authority 340 to retrieve the public key of the issuer. The merchant application 310 uses the public key to decipher the authorization token as shown at 314. The merchant application 310 and/or the merchant system (170 in FIG. 1) may verify the authorization token. For example, the invoice identifier, the authorization identifier, and/or other data may be used to verify that the issuer has verified that the user of the mobile wallet 320 has paid the invoice.

Once the invoice has been verified, the merchant may ship the product to the user. In an example, the mobile wallet 320 may provide a shipping address to the merchant application 310. The merchant system may send tracking information and order status information to the merchant application 310. The merchant application 310 may send the tracking information and order information as shown at 315 to the mobile wallet 320. The mobile wallet 320 may then display the tracking information and/or order status information. The merchant application 310 or merchant system may then request that the issuer 330 clear the authorization token as shown at 316.

The mobile wallet 320, the merchant 310, and the MW provider processes the payment authorization and no existing payment network is used. With the integration between the merchant application 310 and the mobile wallet 320, the merchant application 310 does not need to store or even receive a user's payment credentials, such as credit cards numbers, routing numbers, etc. Further, the mobile wallet 320 may store the shipping and/or billing addresses for the user. This information may be passed to the merchant application 310 via the API. In addition, the merchant system itself also does not need to receive or store this information. Instead, the mobile wallet provider may store this information. This also allows the merchant to use direct communication between the mobile wallet and the issuer instead of a payment network. Accordingly, the merchant may not need to pay any fees for using the payment network.

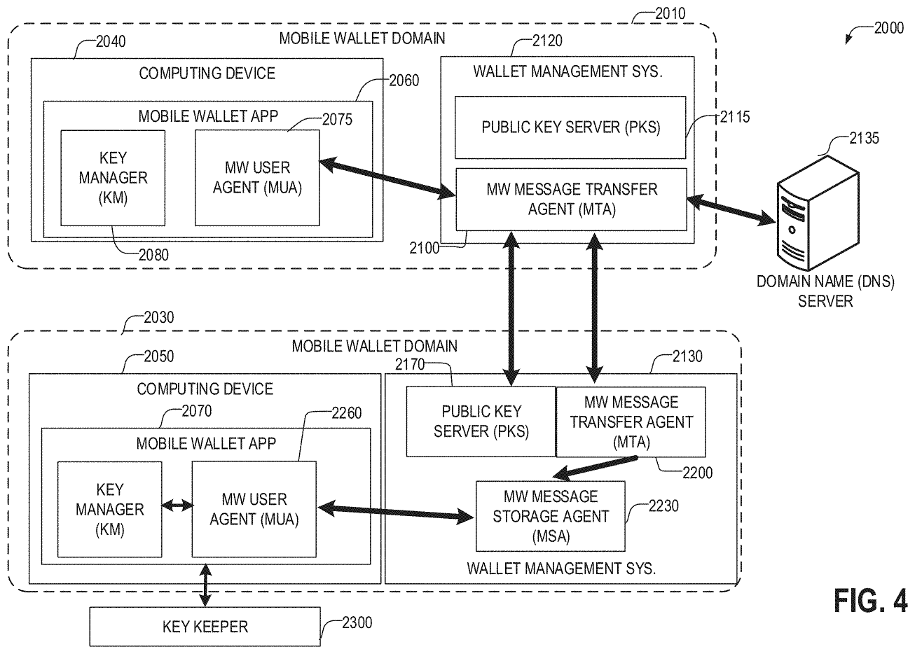

FIG. 4 is a diagram showing one example of a mobile wallet application to mobile wallet application secure digital communication. A first mobile wallet application 2060 executing on a computing device 2040 in a first mobile wallet domain 2010 is sending a message to a second mobile wallet application 2070 executing on a second computing device 2050 in a second mobile wallet domain 2030. In an example, one of the mobile wallet domains may be the issuer and/or the mobile wallet service provider. Mobile wallet application 2060 may include a mobile wallet user agent (MUA) 2075 and a key manager 2080. The MUA 2075 allows users to compose, send and retrieve mobile wallet (MW) messages. Key manager 2080 may one or more of: create, provision, register, store, and manage one or more cryptographic keys. Key manager 2080 may register (or obtain) a public key with a certificate authority (not shown for clarity) and with a PKS 2115.

A mobile wallet application 2060 may provide one or more graphical user interfaces (GUI)s to allow users to compose and edit one or more mobile wallet messages. Before sending a message, the MUA 2075 requests the recipient's public key from the MTA 2100. The PKS 2115 and MTA 2100 may be provided by the mobile wallet management system 2120 of the mobile wallet domain 2010. The PKS 2115 and MTA 2100 may be provided by the same computing device, or different computing devices. While the PKS 2115 and MTA 2100 are shown as part of the mobile wallet management system 2120, they may be provided by separate entities. The MTA and PKS are accessible to computing device 2040 and other computing devices both within the mobile wallet domain 2010 and other devices within other mobile wallet domains, over one or more networks (not shown for clarity). These networks may include one or more portions of: Local Area Networks (LAN), Wide Area Networks (WAN), Metropolitan Area Networks (MAN), the Internet, cellular networks, and the like.

The MTA 2100 first examines the message to determine which mobile wallet domain the recipient is in. If the mobile wallet domain is mobile wallet domain 2010, the MTA may retrieve the public key from the PKS 2115 of mobile wallet domain 2010. If the mobile wallet domain is in another domain, then the MTA checks its DNS cache to determine if it already knows the IP address of the recipient mobile wallet domain's PKS. If the mobile wallet domain is not in the DNS cache, the MW sends a lookup message to DNS server 2135 using the Domain Name System Protocol. DNS server 2135 responds with an IP address of the mobile wallet domain (or an error). Once the address is determined (either through the cache or the DNS server 2135), the MTA 2100 sends a message to a PKS 2170 asking for the public key of the recipient mobile wallet application (e.g., mobile wallet application 2070). The response includes the recipient's public key. The public key is then passed by the MTA 2100 to the MUA 2075.

In some examples, the public key is passed to the MTA 2100 in the form of a digital certificate issued by a Certificate Authority (CA). A digital certificate typically includes the name and other identification information of the holder, the holder's public key, the name of the CA, a serial number, and a validity period. The information in the digital certificate is signed by the issuing CA using the issuing CA's private key. The signature can be verified using the CA's public key (which is known and may be pre-installed on the computing devices 2040, 2050). This may serve as a means to verify that the public key is owned by the recipient. For example, the PKS 2170 may provide a digital certificate created by a trusted CA for the recipient mobile wallet application 2070 in response to the request for the recipient's public key. MUA 2075 (or MTA 2100) may utilize the CA's public key and decrypt the certificate. The certificate may then be checked to determine that the message was not tampered with, and that the public key therein belongs to the mobile wallet application 2070 (e.g., authentication and verification).

Once the MUA 2075 is satisfied with the public key, the MUA 2075 then encrypts the contents of the message with the received public key and sends it to the MTA 2100. The MTA 2100 determines the IP Address of the recipient mobile wallet domain's MTA 2200. In some examples, the MTA 2100 utilizes the IP Address previously determined from the DNS server (e.g., using the cache) when retrieving the public key of the recipient. For example, the PKS 2170 and MTA 2200 may have the same IP Address, or the IP Address of the MTA 2200 may be derivable from the IP Address of the PKS 2170. In other examples a mobile wallet application in mobile wallet domain 2010 may have previously communicated with a mobile wallet application in mobile wallet domain 2030 (and thus the MTA 2100 still has the IP Address in its cache). In other examples, the MTA 2100 may re-request the IP Address from the DNS server 2135.

The MTA 2100 then sends the message 2190 to the MTA 2200 of the mobile wallet management system 2130 of the recipient mobile wallet domain 2030 using the determined IP address. MTA 2200 may send a response to MTA 2100 (which may be forwarded to MUA—but this message is not shown for clarity). MTA 2200 may then send the message to the mobile wallet message storage agent (MSA) 2230. Note that the mobile wallet management system 2120 may also employ a MSA, but it is not shown for clarity. MSA 2230 may then store the message and alert the MUA 2260 of the recipient mobile wallet application 2070 using a notification. When the MUA is interested in receiving the message, the MUA may request it and the MSA may provide it. The MUA may decrypt the message using its private key. The private key may be maintained in the key manager 2290. Key manager 2290 may communicate with key keeper 2300. Key keeper 2300 may be a remote key storage facility to prevent the loss of the cryptographic keys should the computing device 2050 experience a loss in data. For example, the key manager 2290 may store one or more keys of the mobile wallet application 2070 in the key keeper 2300.

In some examples, the mobile wallet application 2070 may utilize a second cryptographic key to encrypt the private key. The private key may then be stored with the mobile wallet management system 2130 in encrypted form. The second cryptographic key may then be stored with the key keeper 2300 and utilized to decrypt the private key should the computing device 2050 need it. The key keeper 2300 may be under control of the user of computing device 2050. This ensures that the private key is not given to the mobile wallet management system 2130 and thus the user can entrust that no one associated with the mobile wallet management system 2130 can access their messages.

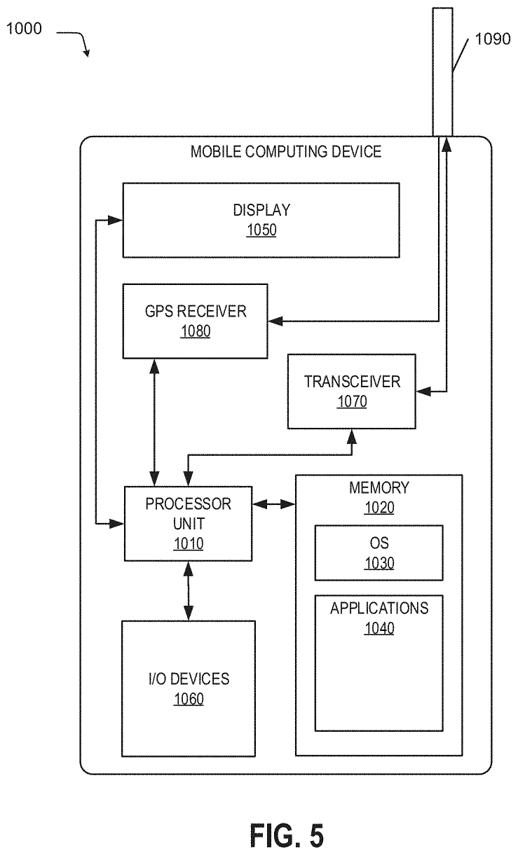

FIG. 5 is a block diagram showing an example architecture 1000 of a mobile computing device. For example, the architecture 1000, for example, may describe any of the computing devices described. The architecture 1000 comprises a processor unit 1014. The processor unit 1014 may include one or more processors. Any of a variety of different types of commercially available processors suitable for mobile computing devices may be used (for example, an XScale architecture microprocessor, a Microprocessor without Interlocked Pipeline Stages (MIPS) architecture processor, or another type of processor). A memory 1020, such as a Random Access Memory (RAM), a Flash memory, or other type of memory or data storage, is typically accessible to the processor. The memory 1020 may be adapted to store an operating system (OS) 1030, as well as application programs 1040. In some examples, the OS may implement software interrupts that cause the architecture 1120 to pause its current task and execute an interrupt service routine (ISR) when an interrupt is received.

The processor unit 1010 may be coupled, either directly or via appropriate intermediary hardware, to a display 1050 and to one or more input/output (I/O) devices 1060, such as a keypad, a touch panel sensor, a microphone, and the like. Such I/O devices 1060 may include a touch sensor for capturing fingerprint data, a camera for capturing one or more images of the user, a retinal scanner, or any other suitable devices. Similarly, in some examples, the processor unit 1010 may be coupled to a transceiver 1070 that interfaces with an antenna 1090. The transceiver 1070 may be configured to both transmit and receive cellular network signals, wireless data signals, or other types of signals via the antenna 1090, depending on the nature of the mobile computing device implemented by the architecture 1100. Although one transceiver 1070 is shown, in some examples, the architecture 1100 includes additional transceivers. For example, a wireless transceiver may be utilized to communicate according to an IEEE 802.11 specification, such as Wi-Fi and/or to a short range communication medium. Some short range communication mediums, such as NFC, may utilize a separate, dedicated transceiver. Further, in some configurations, a GPS receiver 1080 may also make use of the antenna 1090 to receive GPS signals. In addition to or instead of the GPS receiver 1080, any suitable location-determining sensor may be included and/or used including, for example, a Wi-Fi positioning system. In some examples, the architecture (e.g., processor unit 1010) may also support a hardware interrupt. In response to a hardware interrupt, the processor unit 1010 may pause its processing and execute an interrupt service routine (ISR). For example, the alert message 116 may include and/or trigger a hardware interrupt. The ISR for the hardware interrupt may generate the alert, for example, as described herein.

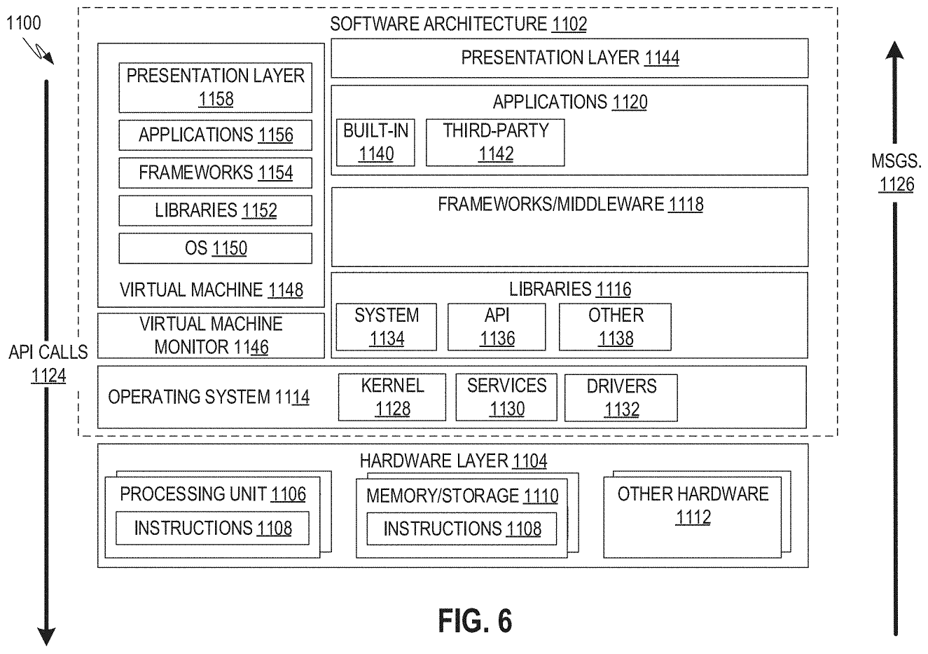

FIG. 6 is a block diagram 1100 showing one example of a software architecture 1102 for a computing device. The architecture 1102 maybe used in conjunction with various hardware architectures, for example, as described herein. FIG. 6 is merely a non-limiting example of a software architecture 1102 and many other architectures may be implemented to facilitate the functionality described herein. A representative hardware layer 1104 is illustrated and can represent, for example, any of the above referenced computing devices. In some examples, the hardware layer 1104 may be implemented according to the architecture 1102 of FIG. 11 and/or the architecture 1000 of FIG. 5.

The representative hardware layer 1104 comprises one or more processing units 1106 having associated executable instructions 1108. Executable instructions 1108 represent the executable instructions of the software architecture 1102, including implementation of the methods, modules, components, and so forth of FIGS. 1-3. Hardware layer 1104 also includes memory and/or storage modules 1110, which also have executable instructions 1108. Hardware layer 1104 may also comprise other hardware as indicated by other hardware 1112 which represents any other hardware of the hardware layer 1104, such as the other hardware illustrated as part of hardware architecture 1200.

In the example architecture of FIG. 11, the software 1102 may be conceptualized as a stack of layers where each layer provides particular functionality. For example, the software 1102 may include layers such as an operating system 1114, libraries 1116, frameworks/middleware 1118, applications 1120 and presentation layer 1144. Operationally, the applications 1120 and/or other components within the layers may invoke application programming interface (API) calls 1124 through the software stack and receive a response, returned values, and so forth illustrated as messages 1126 in response to the API calls 1124. The layers illustrated are representative in nature and not all software architectures have all layers. For example, some mobile or special purpose operating systems may not provide a frameworks/middleware layer 1118, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. In some examples, the services 1130 include an interrupt service. The interrupt service may detect the receipt of a hardware or software interrupt and, in response, cause the architecture 1102 to pause its current processing and execute an interrupt service routine (ISR) when an interrupt is received. The ISR may generate the alert, for example, as described herein.

The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1116 may provide a common infrastructure that may be utilized by the applications 1120 and/or other components and/or layers. The libraries 1116 typically provide functionality that allows other software modules to perform tasks in an easier fashion than to interface directly with the underlying operating system 1114 functionality (e.g., kernel 1128, services 1130 and/or drivers 1132). The libraries 1116 may include system 1134 libraries (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 9D in a graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks 1118 (also sometimes referred to as middleware) may provide a higher-level common infrastructure that may be utilized by the applications 1120 and/or other software components/modules. For example, the frameworks 1118 may provide various graphic user interface (GUI) functions, high-level resource management, high-level location services, and so forth. The frameworks 1118 may provide a broad spectrum of other APIs that may be utilized by the applications 1120 and/or other software components/modules, some of which may be specific to a particular operating system or platform.

The applications 1120 includes built-in applications 1140 and/or third party applications 1142. Examples of representative built-in applications 1140 may include, but are not limited to, a contacts application, a browser application, a book reader application, a location application, a media application, a messaging application, and/or a game application. Third party applications 1142 may include any of the built in applications as well as a broad assortment of other applications. In a specific example, the third party application 1142 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third party application 1142 may invoke the API calls 1124 provided by the mobile operating system such as operating system 1114 to facilitate functionality described herein.

The applications 1120 may utilize built in operating system functions (e.g., kernel 1128, services 1130 and/or drivers 1132), libraries (e.g., system 1134, APIs 1136, and other libraries 1138), frameworks/middleware 1118 to create user interfaces to interact with users of the system. Alternatively, or additionally, in some systems interactions with a user may occur through a presentation layer, such as presentation layer 1144. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 11, this is illustrated by virtual machine 1148. A virtual machine creates a software environment where applications/modules can execute as if they were executing on a hardware computing device. A virtual machine is hosted by a host operating system (operating system 1114) and typically, although not always, has a virtual machine monitor 1146, which manages the operation of the virtual machine as well as the interface with the host operating system (i.e., operating system 1114). A software architecture executes within the virtual machine such as an operating system 1150, libraries 1152, frameworks/middleware 1154, applications 1156 and/or presentation layer 1158. These layers of software architecture executing within the virtual machine 1148 can be the same as corresponding layers previously described or may be different.

FIG. 12 is a block diagram illustrating a computing device hardware architecture 1200, within which a set or sequence of instructions can be executed to cause the machine to perform examples of any one of the methodologies discussed herein. For example, the architecture 1200 may execute the software architecture 1102 described with respect to FIG. 11. The architecture 1200 may operate as a standalone device or may be connected (e.g., networked) to other machines. In a networked deployment, the architecture 1200 may operate in the capacity of either a server or a client machine in server-client network environments, or it may act as a peer machine in peer-to-peer (or distributed) network environments. The architecture 1200 can be implemented in a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify operations to be taken by that machine.

Example architecture 1200 includes a processor unit 1202 comprising at least one processor (e.g., a central processing unit (CPU), a graphics processing unit (GPU) or both, processor cores, compute nodes, etc.). The architecture 1200 may further comprise a main memory 1204 and a static memory 1206, which communicate with each other via a link 1208 (e.g., bus). The architecture 1200 can further include a video display unit 1210, an alphanumeric input device 1212 (e.g., a keyboard), and a user interface (UI) navigation device 1214 (e.g., a mouse). In some examples, the video display unit 1210, input device 1212 and UI navigation device 1214 are incorporated into a touch screen display. The architecture 1200 may additionally include a storage device 1216 (e.g., a drive unit), a signal generation device 1218 (e.g., a speaker), a network interface device 1220, and one or more sensors (not shown), such as a global positioning system (GPS) sensor, compass, accelerometer, or other sensor.

In some examples, the processor unit 1202 or other suitable hardware component may support a hardware interrupt. In response to a hardware interrupt, the processor unit 1202 may pause its processing and execute an interrupt service routine (ISR), for example, as described herein.

The storage device 1216 includes a machine-readable medium 1222 on which is stored one or more sets of data structures and instructions 1224 (e.g., software) embodying or utilized by any one or more of the methodologies or functions described herein. The instructions 1224 can also reside, completely or at least partially, within the main memory 1204, static memory 1206, and/or within the processor 1202 during execution thereof by the architecture 1200, with the main memory 1204, static memory 1206, and the processor 1202 also constituting machine-readable media. Instructions stored at the machine-readable medium 1222 may include, for example, instructions for implementing the software architecture 1102, instructions for executing any of the features described herein, etc.

While the machine-readable medium 1222 is illustrated in an example to be a single medium, the term “machine-readable medium” can include a single medium or multiple media (e.g., a centralized or distributed database, and/or associated caches and servers) that store the one or more instructions 1224. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1224 can further be transmitted or received over a communications network 1226 using a transmission medium via the network interface device 1220 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A system comprising:
a computing device comprising at least one processor unit and a memory in communication with the at least one processor unit, wherein the computing device is programmed to execute operations comprising:
determining, by a merchant application, a plurality of mobile wallet applications that are capable of interfacing directly with the merchant application;
sending, to a mobile wallet application of the plurality of mobile wallet applications, invoice data associated with an invoice from the merchant application;
receiving, an authorization token of an issuer, the authorization token being sent in response to receiving an indication to pay the invoice;
querying a certificate authority for a public key associated with an issuer;
receiving the public key from the certificate authority;
deciphering the authorization token with the public key to verify the invoice has been paid; and
sending a request to clear the authorization token.

2. The system of claim 1, wherein the authorization token is sent via an application program interface.

3. The system of claim 1, wherein the authorization token includes one of an issuer identifier, an invoice identifier, or an authorization identifier.

4. The system of claim 3, wherein deciphering the authorization token further includes verifying one of the issuer identifier, the invoice identifier, or the authorization identifier in order to verify that the issuer has paid the invoice.

5. The system of claim 1, wherein the authorization token is encrypted with a private key of the issuer.

6. The system of claim 1, wherein the computing device is further programmed to perform operations comprising decrypting the authorization token using the public key to verify the authorization token.

7. The system of claim 1, wherein the computing device is further programmed to perform operations comprising:
storing an invoice identifier associated with the invoice, the invoice comprising the invoice identifier; and
comparing an invoice identifier from the deciphered a the stored invoice identifier to verify the authorization token.

8. A method comprising:
determining, by a merchant application, a plurality of mobile wallet applications that are capable of interfacing directly with the merchant application;
sending, to a mobile wallet application of the plurality of mobile wallet applications, invoice data associated with an invoice from the merchant application;
receiving, an authorization token of an issuer, the authorization token being sent in response to receiving an indication to pay the invoice;
querying a certificate authority for a public key associated with an issuer;
receiving the public key from the certificate authority;
deciphering the authorization token with the public key to verify the invoice has been paid; and
sending a request to clear the authorization token.

9. The method of claim 8, wherein the authorization token is sent via an application program interface.

10. The method of claim 8, wherein the authorization token includes one of an issuer identifier, an invoice identifier, or an authorization identifier.

11. The method of claim 10, wherein deciphering the authorization token further includes verifying one of the issuer identifier, the invoice identifier, or the authorization identifier in order to verify that the issuer has paid the invoice.

12. The method of claim 8, wherein the authorization token is encrypted with a private key of the issuer.

13. The method of claim 8, wherein the method further comprises decrypting the authorization token using the public key to verify the authorization token.

14. The method of claim 8, wherein the method further comprises:
storing an invoice identifier associated with the invoice, the invoice comprising the invoice identifier; and
comparing an invoice identifier from the deciphered authorization token to the stored invoice identifier to verify the authorization token.

15. A non-transitory machine-readable medium comprising instructions thereon that, when executed by at least one processor unit, causes the at least one processor unit to perform operations comprising:
determining, by a merchant application, a plurality of mobile wallet applications that are capable of interfacing directly with the merchant application;
sending, to a mobile wallet application of the plurality of mobile wallet applications, invoice data associated with an invoice from the merchant application;
receiving, an authorization token of an issuer, the authorization token being sent in response to receiving an indication to pay the invoice;
querying a certificate authority for a public key associated with an issuer;
receiving the public key from the certificate authority;
deciphering the authorization token with the public key to verify the invoice has been paid; and
sending a request to clear the authorization token.

16. The non-transitory machine-readable medium of claim 15, wherein the authorization token is sent via an application program interface.

17. The non-transitory machine-readable medium of claim 15, wherein the authorization token includes one of an issuer identifier, an invoice identifier, or an authorization identifier and deciphering the authorization token further includes verifying one of the issuer identifier, the invoice identifier, or the authorization identifier in order to verify that the issuer has paid the invoice.

18. The non-transitory machine-readable medium of claim 15, wherein the authorization token is encrypted with a private key of the issuer.

19. The non-transitory machine-readable medium of claim 15, the operations further comprising decrypting the authorization token using the public key to verify the authorization token.

20. The non-transitory machine-readable medium of claim 15, the operations further comprising:
storing an invoice identifier associated with the invoice, the invoice comprising the invoice identifier; and
comparing an invoice identifier from the deciphered authorization token to the stored invoice identifier to verify the authorization token.
